(19) United States
(12) Patent Application Publication
(10) Pub. No.: US 2010/0204809 A1
(43) Pub. Date: Aug. 12, 2010

(54) Method for Operating an Automation System, Corresponding Computer Program and System or Device that Operates According to the Method

(75) Inventor: Thomas Reuter, Karlsruhe (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/702,896

(22) Filed: Feb. 9, 2010

(30) Foreign Application Priority Data
Feb. 9, 2009 (EP) EP09001787

(51) Int. Cl. G05B 19/42

(52) U.S. Cl. 700/86

(57) ABSTRACT

A method for operating an automation system, a corresponding computer program for implementing the method and a system or device that operates in accordance with according to the method, wherein a control program comprises a plurality of software modules and subprograms as an automation solution for a technical process. The software modules are invoked by individual subprograms in accordance with a predefined call sequence, wherein a call sequence permanently configured for the software modules in a call vector is stored in a call specification dataset, and where the call specification dataset is available for the subprogram or for each subprogram for the purpose of invoking the software modules in accordance with the call specification dataset.

### BACKGROUND OF THE INVENTION

The invention relates to a method for operating an automation system, a corresponding computer program for implementing the method and a system or device that operates according to the method, in particular by executing the computer program. Specifically, the invention relates to the organization of components of a control program that is executed by the automation system or individual elements of the automation system, e.g., one or more automation devices, as an automation solution for controlling and/or monitoring a technical process, i.e., an industrial process, such as a manufacturing process. For control programs of this kind it is known that these comprise a plurality of software modules and subprograms. For certain types of subprograms the term “task” has also become established in the professional community, so both terms will be used synonymously in the following.

During an execution of the control program, the software modules are called or “invoked” by the subprogram or by individual subprograms. Here, the call sequence is predefined, with the result that the predefined call sequence also determines the functionality of the control program in the sense that, e.g., it is ensured that a first software module is invoked before a second software module, such that the second software module can access data that has been generated, provided or modified by the first software module.

Typically, graphical development systems (e.g., engineering systems) are used to produce the control program and the software modules and subprograms contained therein. Such development systems also support, e.g., graphical languages, reference being made by way of example to the programming language known by the acronym CFC (Continuous Function Chart), by means of which software modules are represented in a plan as a function block having inputs and outputs and are graphically interconnected. Such function blocks are then based on, e.g., function modules, functions or inline code. The function blocks are created in what are referred to as plans. The so-called data flow between the software modules is configured by means of this graphical configuration in the respective plan. In order to enable the configured plan and the software modules included therein to be executed, the modules must be provided for invocation by the control program.

The control program comprises a main program and one or more subprograms, where it has become established in accordance with a structuring of the automation solution that the main program includes a call of at least one subprogram and that the subprogram or each subprogram comprises calls to further subprograms and/or to the software modules. With special-purpose solutions, it can also happen that a functionality which, according to the foregoing description, is equivalent in hierarchical terms to a main program is present, not as variable software, but in contrast is coded, e.g., in firmware such that a predefined number of subprograms/tasks is permanently embedded in the plan and the “main program” codes this fixed planning. Suitable candidates as subprograms, i.e., tasks, are user-defined tasks, e.g., tasks executed in a fixed timeframe and accordingly referred to as time tasks, or system tasks, e.g., for warm start or cold start, diagnostics, error tasks or event tasks. In order to enable software modules to be invoked in the control program, where the modules are assigned to individual subprograms of the control program.

A disadvantage with the prior art solutions in which calls to the software modules are provided by one or more subprograms is that the assignment of the software modules to the respective subprograms is performed manually and on a purely task-oriented basis. Toward that end, the individual software modules or even entire plans are assigned directly to individual tasks by a control flow editor, and then manually inserted into an execution sequence per task.

It is often necessary to assign one and the same software module to different tasks (time tasks, system tasks, error tasks or event tasks). Consequently, the method for assigning the individual software modules to the different tasks is very laborious and time-consuming, as well as being susceptible to errors. Furthermore, handling the task assignment, i.e., when modifying, moving, subdividing and merging plans and software modules, is very complex and difficult for the user to track and reproduce.

In addition, plans comprising software modules developed, e.g., in CFC are granularly decoupled in terms of the data flow, but tightly interwoven in terms of the control flow per task. As a result, in cases of a project on which a number of developers are working (multiuser engineering), the plan cannot be secured as a granular unit for the respective developer to protect against conflicting accesses by other developers (locking).

### SUMMARY OF THE INVENTION

It is therefore an object of the invention to provide a method and automation system that permits securing of a plan as a granular unit for a respective developer to protect against conflicting accesses by other developers.

This and other objects and advantages are achieved in accordance with the invention by a method for operating an automation system having a control program as an automation solution for a technical, i.e., industrial, process requiring to be controlled and/or monitored, where the control program comprises a plurality of software modules and subprograms (tasks), the software modules are invoked by individual subprograms in accordance with a predefined call sequence during an execution of the control program, and where the call sequence is coded in a call specification dataset.

In accordance with the invention, the call specification dataset is a compilation of data which relates exclusively to callable software modules and their sequence, which means that data in the manner of program code instructions that were previously necessary in a subprogram in solutions according to the prior art to effect the call of a software module at specific positions of the subprogram are not to be understood as a call specification dataset of said type. Such calls would be distributed over the respective subprogram, so already against this background it is not possible to speak of a dataset as a related collection of data. Moreover, calls to software modules from a subprogram are specifically not data, but according to general understanding are program code instructions, so that in this respect, an interpretation of calls to software modules directly from the subprogram also does not come into consideration as a call specification dataset or part of such a dataset.

In accordance with the invention, a call sequence permanently configured for the software modules is stored in a call specification dataset, and the call specification dataset for the subprogram or for each subprogram is available for invoking the software modules in accordance with the call specification dataset. The call specification dataset can therefore be created independently of the respective subprogram, and in order to invoke the relevant software modules in each case the subprogram accesses the call specification dataset. In addition, the call of the respective software modules is effected by means of the access with the aid of the data in the call specification dataset in accordance with the call sequence coded in the call specification dataset.

As a result, the call sequence in accordance with the invention for the software modules is advantageously concentrated in the call specification dataset at a central point and all subprograms in which provision is made for calling software modules can access such a call specification dataset. The sequence thus specified is therefore adhered to for each subprogram.

In this way, on the one hand, unfavorable call sequences of the software modules are avoided while, on the other hand, configuring the automation solution is simplified because when a call specification dataset is used the risk that the call to a software module is unintentionally omitted is significantly reduced. As a result, it is easier to maintain an overview on the development of automation solutions and to that extent makes the development faster and qualitatively better. It additionally results in easier maintainability because the type and sequence of the calls to software modules are now coded at only a central point.

In preferred embodiments, the call specification dataset for each subprogram contained in the control program includes an activation vector. By means of entries corresponding to the call sequence, the activation vector specifies which software modules are invoked by the respective subprogram during operation. Thus, if the control program comprises a first, second and third software module and the call sequence names the third software module before the first software module and then the second software module, the basic call sequence, i.e., firstly the third software module, secondly the first software module and thirdly the second software module, is specified therewith. The activation vector thus enables situations to be taken into account according to which individual subprograms do not have to invoke all the software modules. If a first subprogram has to call all three software modules, the activation vector will receive an entry coding a provided call to the three software modules at a first, second and third position. If a second subprogram only needs to invoke the first software module, a corresponding activation vector will include entries at the first and third position (i.e. in relation to the third and second software module), the entries coding that the third and second software module do not have to be invoked, and at the second position will include an entry coding that the first software module will be invoked. The basic sequence of the software modules therefore remains unchanged in accordance with the specified activation sequence. The calls to individual software modules can effectively be switched on and off by the activation vector.

In an alternative embodiment, for taking account of situations in which subprograms do not have to invoke all the software modules, a separate call specification dataset is provided for each subprogram contained in the control program. With such subprogram-specific call specification datasets, each dataset includes a call sequence specified for the subprogram. If a subprogram is not to invoke a specific software module, this is not included in the call sequence.

For both of the contemplated embodiments for providing a solution in accordance with the invention, i.e., the activation vector and the subprogram-specific call specification dataset, it is provided in a preferred embodiment that such data structures are only created for those subprograms that also actually invoke software modules. Otherwise, it would be possible for each subprogram that invokes no software modules effectively to create an empty data structure; this, however, unnecessarily occupies memory space, with the result that this additional differentiation is beneficial.

In the case of control programs having a greater number of software modules, these are usually organized in groups, module groups of this kind arising, e.g., as a result of individual plans, as they are called, produced in a development environment. A plan or the like thus specifies a group membership of the software modules included in each case, and all software modules of a plan are members of the same module group. In such situations, it is advantageous that each module group, i.e., each plan, is assigned a call specification dataset. In the case of a plurality of module groups, a plurality of call specification datasets are produced in this way, and these call specification dataset are available for the subprogram or for each subprogram for invoking the software modules in accordance with the respective call specification dataset and the call sequence coded therein.

The advantage of using one call specification dataset in each case for each module group resides in the easier maintainability of the automation solution. Each call specification dataset remains per se clearly structured, according to the scale of the respective module group, which does not necessarily apply in the same way if all the software modules were to be included in one call specification dataset across module group boundaries. A sequence in which the call sequence of a majority of call specification datasets is taken into account can be specified by a configurable call sequence at a next-higher level or it can result implicitly from an ordinal number resulting for the module groups, e.g., such that the call specification dataset of a first module group is initially taken into account, and then the call specification dataset of, for example, a second module group is taken into account.

The call specification datasets can include an activation vector for a plurality of subprograms in each case, or it can be provided according to an alternative embodiment in which a separate call specification dataset is provided in each case for each subprogram and for each module group.

In preferred embodiments, the call specification dataset or each call specification dataset is assigned in each case to one module group. Each module group thus includes its own call specification dataset. Furthermore, the fixed assignment of module group and call specification dataset enables the referencing of the software modules that are to be invoked in each case to be simplified in that, e.g., a relative addressing scheme which relates only to the respective module group is sufficient.

The method in accordance with the disclosed embodiments is preferably implemented in software, with the result that the contemplated embodiments of the invention also relate to a computer program having program code instructions executable by means of a computer for implementing the method. Such computer programs are typically stored on digital storage media, that is to say electronic, magnetic and optical etc. storage media, so in that respect the invention also relates to a storage medium of the foregoing type having a computer program for implementing the invention. Finally, the invention also relates to a computer system, in particular to a programming device which can be connected to or is connected to an automation system on which a computer program of the foregoing type is loaded. By means of such a computer system, the call specification dataset is created as a container for the permanently configured call sequence. The call specification dataset is then available for the execution of the control program by an automation device.

Thus, the contemplated embodiments of the invention also relate to an automation system having an automation device which comprises a memory and a processing unit, where a control program is stored in the memory as an automation solution for a technical process requiring to be controlled and/or monitored and where the control program comprises a plurality of software modules and subprograms. Here, the software modules are invoked by individual subprograms in accordance with a predefined call sequence during an execution of the control program by means of the processing unit. The automation system of the contemplated embodiment includes subprograms that are called in accordance with a call specification dataset which was created based on the method in accordance with the contemplated embodiments of the invention.

The exemplary embodiment or each exemplary embodiment is not to be understood as a restriction of the invention. Rather, numerous variations and modifications are possible within the scope of the present disclosure, in particular such variants and combinations which can be derived by the person skilled in the art with regard to the solution of the problem, e.g., by combination or modification of individual features and elements or method steps in connection with those described in the general or specific description part as well as contained in the claims and/or the drawing and lead as a result of combinable features to a new object or to new method steps or method step sequences.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the invention is explained in more detail below with reference to the drawings. Objects or elements corresponding to one another are labeled with the same reference signs in all the figures, in which:

FIG. 1 shows an automation system having a number of communicatively connected automation devices for the purpose of controlling and/or monitoring a technical process in accordance with an exemplary embodiment of the invention;

FIG. 2 shows components of a control program executed as an automation solution by one or more automation devices, there being included therein subprograms and software modules which can be invoked by such subprograms, in accordance with an embodiment of the invention; and

FIG. 3 shows a flow chart of the method in accordance with an embodiment of the invention.

### DETAILED DESCRIPTION OF THE PRESENTLY PREFERRED EMBODIMENTS

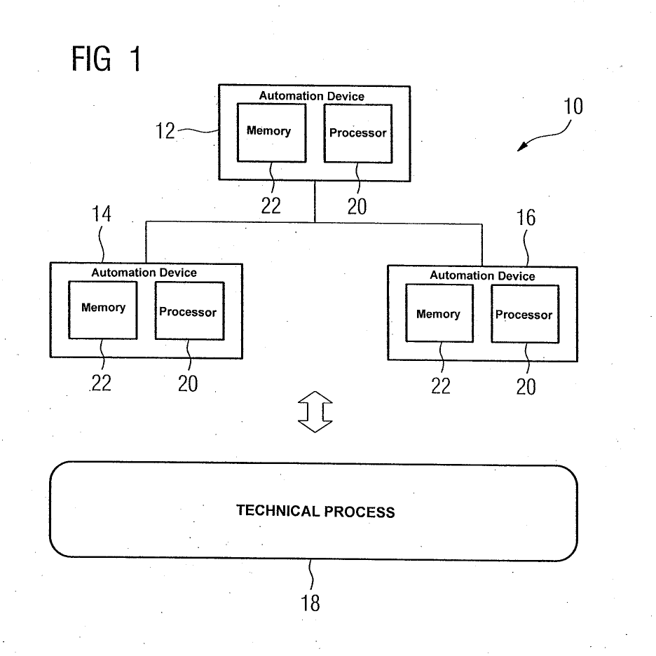

FIG. 1 is a schematic illustration of an automation system 10 in accordance with an embodiment of the invention which comprises a plurality of communicatively connected automation devices 12, 14, 16. The automation system 10 is provided overall for controlling and/or monitoring a technical process 18, i.e., an industrial technical process, such as a manufacturing process. Each automation device 12, 14, 16, in which simple automation systems 10 can also comprise only one individual automation device 12, 14, 16, has a processing unit 20 or a processor and a memory 22. Stored in the memory 22, as an automation solution, is a control program which is executed during operation of the respective automation device 12, 14, 16 by the processing unit 20 of the automation device 12, 14, 16 in a manner which is known per se.

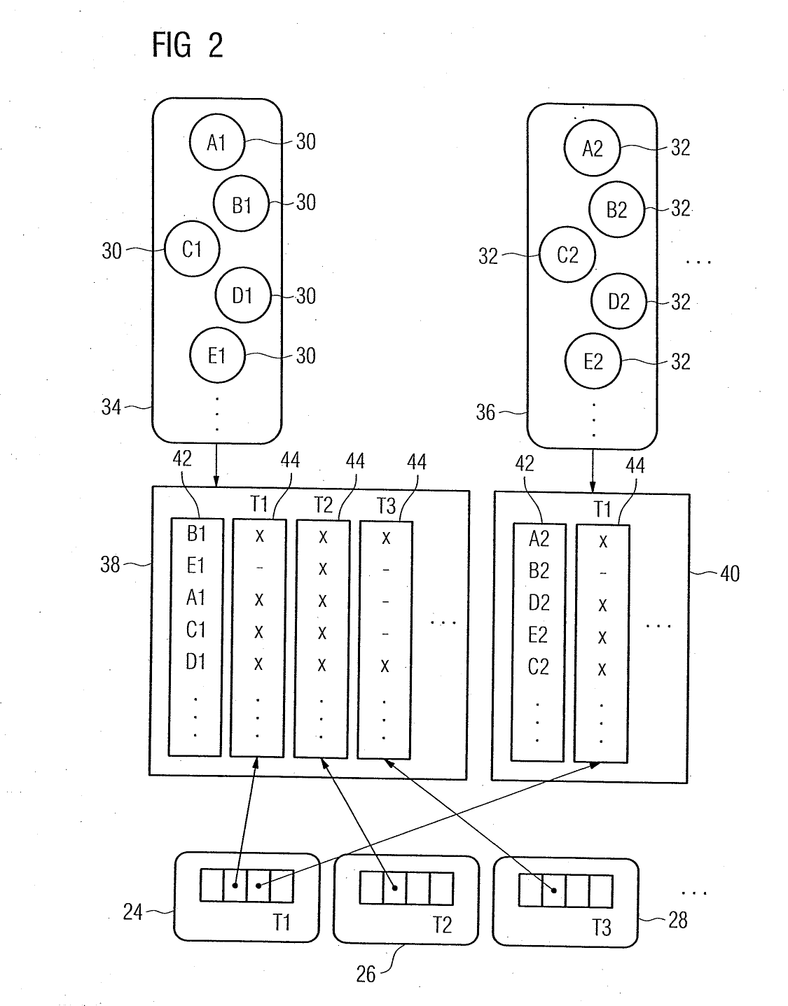

FIG. 2 shows as components of such control programs the subprograms 24, 26, 28, which are also referred to as tasks and accordingly are designated in the illustration by “T1”, “T2”, “T3”. The control program further comprises the software modules 30, 32 which, for further differentiation in the illustration, are also designated symbolically by “A1”, “B1”, “C1”, “D1”, “E1”; “A2”, “B2”, “C2”, “D2”, “E2”. In the exemplary illustration of FIG. 2, a grouping of the individual software modules 30, 32 is produced based on a membership of in each case different module groups 34, 36, which are created, e.g., in the form of so-called plans during the development of the control program.

An execution of individual or multiple subprograms 24, 26, 28 is effected as a result of a corresponding call in the respective control program. Each subprogram 24, 26, 28 can require one or more software modules 30, 32 to be invoked. In order to simplify specification of a sequence in which such calls are made (call sequence), the contemplated embodiments of the invention use a call specification dataset 38, 40. Each call specification dataset 38, 40 includes a call vector 42 which codes the respective call sequence. In the illustration in FIG. 2, the call sequence coded in each case is represented by repetition of the symbolic identifiers of the individual software modules 30, 32. Thus, when the approach in accordance with the disclosed embodiments of the invention is used, a subprogram 24, 26, 28 accesses the call specification dataset 38, 40 and the call vector 42 contained therein in each case to effect an invocation of the required software modules 30, 32.

If not every subprogram 24, 26, 28 is required to call all the software modules 30, 32, either a separate call specification dataset 38, 40 can be provided for each subprogram 24, 26, 28 or an activation vector 44 is added to supplement each call specification dataset 38, 40. When an activation vector 44 is used, each call specification dataset 38, 40 includes a separate activation vector 44 for each subprogram 24, 26, 28 that has to invoke software modules 30, 32, and the respective software modules 30, 32 are called in accordance with the activation vector 44 in the order specified by the call vector 42. This is shown in the illustration in FIG. 2 by the arrows originating from the individual subprograms 24, 26, 28 and pointing to each individual activation vectors 44. According to the number of entries in the call vector 42, each activation vector 44 contains data which may possibly code a call to the corresponding software module 30, 32 (represented by a cross (“x”) in the exemplary illustration). Software modules 30, 32 not requiring to be invoked by a subprogram 24, 26, 28 are effectively deactivated in the activation vector 44 (shown for the subprogram having the symbolic identifier “T1”, e.g., for the software module having the symbolic identifier “E1”).

With continued reference to FIG. 2, shown therein is the special case whereby a control program comprises software modules 30, 32 that are organized in different module groups 34, 36. As shown, a separate call specification dataset 38, 40 is provided for each module group 34, 36 of the different type of module groups and the instance of an underlying data structure representing the call specification dataset 38, 40 is permanently connected to the data structure that implements a module group 34, 36, which is illustrated by the arrows running between each module group 34, 36 and associated call specification dataset 38, 40. Such a grouping of the data encompassed by the respective data structures enables a particularly efficient calling of the software modules 30 by the respective call specification dataset 38, 40, e.g., because the call vector 42 for coding the respective software modules 30, 32 can use a relative addressing scheme since a unique resolution of the references involved in each case is possible due to the association between module group 34, 36 and call specification dataset 38, 40.

For the subprograms 24, 26, 28, the boxes arranged next to one another are intended to represent individual program code instructions and those program code instructions, from which an arrow extends pointing to an activation vector 44, are to be regarded as program code instructions, for invoking the software modules 30, 32 coded by the call vector 42.

A specification of the call specification dataset 38, 40 with call vector 42 and, if necessary activation vector 44, is effected by an automation device 12, 14, 16 (FIG. 1) which acts as a programming device in the automation system 10 and is possibly only temporarily part of the automation system 10. One or more call specification datasets 38, 40 are used by the automation devices 12, 14, 16 permanently included in the automation system 10 for implementing the respective automation solution during the execution of the respective control program.

In sum, the contemplated embodiments of the invention comprise a method for operating an automation system, a corresponding computer program for implementing the method and a system or device that operates in accordance with the method, where a control program comprises, as an automation solution for a technical process 18, a plurality of software modules 30, 32 and subprograms 24, 26, 28. The plurality of the software modules 30, 32 are invoked by individual subprograms 24, 26, 28 in accordance with a predefined call sequence, where a call sequence permanently configured for the software modules 30, 32 in a call vector 42 is stored in a call specification dataset 38, 40, and where the call specification dataset 38, 40 is available for the subprogram or for each subprogram 24, 26, 28 for invoking the software modules 30, 32 in accordance with the call specification dataset 38, 40.

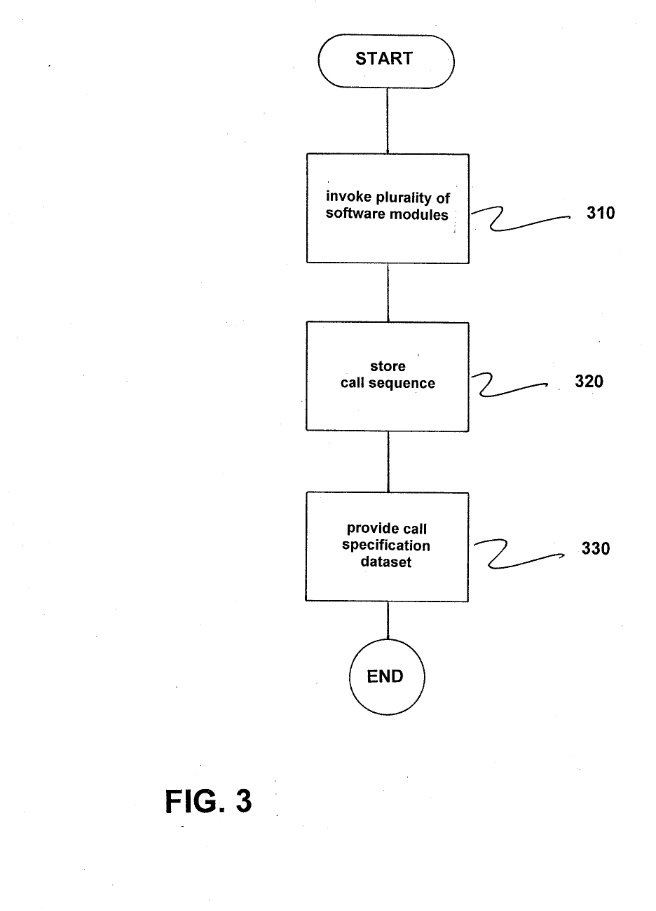

FIG. 3 is a flow chart illustrating the method in accordance with an embodiment of the invention. The method comprises invoking a plurality of software modules (30, 32) by a plurality of individual subprograms (24, 26, 28) in accordance with a predefined call sequence during an execution of the automation solution, as indicated in step 310. Next, the predefined call sequence permanently configured for the plurality of software modules (30, 32) is stored in a call specification dataset, as indicated in step 320. The call specification dataset (38, 40) for at least one of the plurality of subprograms is then provided such that the plurality of software modules (30, 32) can be invoked to invoke the plurality of software modules in accordance with the call specification dataset (38, 40) during execution of at least one of the plurality of subprograms.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A method for operating an automation system having an automation solution for a technical process that requires at least one of controlling and monitoring, wherein the automation solution comprises a plurality of software modules and a plurality of subprograms, the method comprising:
invoking said plural software modules by said plural subprograms in accordance with a predefined call sequence during an execution of the automation solution;
storing the predefined call sequence permanently configured for said plural software modules in a call specification dataset; and
providing the call specification dataset for at least one of said plural subprograms such that said plural software modules are invokeable in accordance with the call specification dataset during execution of at least one of said plural subprograms.

2. The method as claimed in claim 1, wherein the call specification dataset includes an activation vector for each of said plural subprograms that is contained in the automation solution and invokes at least one of said plural software modules; and
wherein the activation vector specifies, by entries corresponding to an order of the call sequence, which of said plural software modules will be invoked during operation of each respective one of said plural subprograms.

3. The method as claimed in claim 1, wherein a separate call specification dataset is provided for each of said plural subprograms that is contained in the automation solution and invokes at least one of said plural software modules.

4. The method as claimed in claim 1, wherein said plural software modules form members of a plurality of module groups, a separate call specification dataset is assigned to each of said plural module groups, and wherein call specification datasets for said at least one subprogram are available for invoking said plural software modules in accordance with the respective call specification datasets.

5. The method as claimed in claim 2, wherein said plural software modules form members of a plurality of module groups, a separate call specification dataset is assigned to each of said plural module groups, and wherein call specification datasets for said at least one subprogram are available for invoking said plural software modules in accordance with the respective call specification datasets.

6. The method as claimed in claim 3, wherein said plural software modules form members of a plurality of module groups, a separate call specification dataset is assigned to each module of said plural module groups, and wherein call specification datasets for said at least one subprogram are available for invoking said plural software modules in accordance with the respective call specification datasets.

7. The method as claimed in claim 4, wherein each said call specification dataset is assigned to a respective one of said plural module groups.

8. The method as claimed in claim 1, wherein the automation solution comprises a control program.

9. A computer program having program code executing on a processer which, when used on a computer apparatus, causes an automation system to at least one of control and monitor a technical process, the computer program comprising:
program code for invoking said plural software modules by said plural subprograms in accordance with a predefined call sequence during an execution of the automation solution;
program code for storing the predefined call sequence permanently configured for said plural software modules in a call specification dataset; and
program code for providing the call specification dataset for at least one of said plural subprograms such that said plural software modules are invokeable in accordance with the call specification dataset during execution of at least one of said plural subprograms.

10. A digital storage medium storing the computer program as claimed in claim 9.

11. A computer apparatus comprising a programming device disposed in an automation system or configured for implementation in the automation system, the computer apparatus having the computer program of claim 9 loaded therein.

12. The computer apparatus of claim 11, further comprising:
a digital storage medium storing the computer program and generating control signals interacting with the programming device.

13. An automation system comprising:
at least one automation device including a memory having an automation solution stored therein for a technical process requiring to be at least one of controlled and monitored, the at least one automation device further including a processing unit;
wherein the automation solution comprises a plurality of software modules and subprograms;
wherein said plural software modules are invoked by individual subprograms in accordance with a predefined call sequence during an execution of the automation solution by the processing unit; and
wherein the individual subprograms are invoked in accordance with a call specification dataset having a call sequence permanently configured for each of said plural software modules.

14. The automation system of claim 12, wherein the automation solution comprises a control program.
